(19) United States
(12) Patent Application Publication
(10) Pub. No.: US 2009/0085754 A1
(43) Pub. Date: Apr. 2, 2009

(54) Alarm Device For a Kitchen Range or Range Hood

(76) Inventor: Matti Myllymaki, Helsinki (FI)

Correspondence Address: DRINKER BIDDLE & REATH (DC), 1500 K STREET, N.W., SUITE 1100, WASHINGTON, DC, 20005-1209, US

(21) Appl. No.: 12/087,996

(22) PCT Filed: Jan. 3, 2007
(86) PCT No.: PCT/FI2007/050002

§ 371 Date: Dec. 5, 2008

(30) Foreign Application Priority Data
Jan. 20, 2006 (FI) 20060053

(51) Int. Cl. G08B 17/00

(52) U.S. Cl. 340/584

(57) ABSTRACT

The invention relates to an alarm device (1, 11), which identifies if the plate of a gas or electric range is on at idle or the grease filter of a range hood is excessively dirty. The device comprises at least one temperature sensor (6, 9) and identification electronics (4), which identifies a sensor message and on that basis effects the activation of an alarm or a control output. The identification electronics (4) identifies a rate of change in the temperature of the sensor or sensors (6, 9) and/or a temperature difference between the sensors (6, 9) and/or a rate of change in the temperature difference between the sensors (6, 9) and effects the activation of an alarm (5) or a control output (2) as the rate of change in temperature and/or the temperature difference and/or the rate of change in a temperature difference exceeds a given value.

The invention relates to an alarm device for a kitchen range and range hood, which signals if the plate of a gas or electric range is left on at idle or if the grease filter of a range hood needs cleaning. The device comprises at least one temperature sensor and identification electronics, which identifies a sensor message and on that basis effects the activation of an alarm or a control output.

Almost 30% of electrical fires are caused by a kitchen range and the risk of flue and house fires is significantly increased by excessive dirtiness of a grease filter in the range hood.

A majority of kitchen range fires are caused by misuses, the most typical of which is forgetting the plate or switching it on inadvertently. Typical problem groups are elderly users, as well as children and pets. Elderly users tend to forget the range on and children as well as pets turn the range plate inadvertently on. Judging the dirtiness of a range hood's grease filter is awkward and in many cases it is washed too infrequently, thus increasing the risk of flue fire and impairing the quality of indoor air by being unable to exhaust cooking fumes.

There are prior known tracking and alarm devices operable in association with a kitchen range, which set off an alarm when the range temperature rises to a sufficient height, exceeding a set limit temperature, and switch the range off automatically. Prior known are also timers, which adjust themselves according to the output of a range and which disconnect the range from power supplies when any of the plates is left on at a high output for an excessively long time.

A problem with these prior known solutions is that the response times thereof are excessively long when a plate is left on at idle or that the timers, which adjust themselves according to output, disconnect power supplies too quickly when a large amount of food is being prepared. As a result of an excessively slow response, there is often enough time for the user to leave the site before an alarm is given. Also possible obstacles, such as a hand or dirt between the sensor and the area under surveillance, may deny or delay an alarm. Ambient temperature may also have an effect on the activation of an alarm in some appliances. Solutions involving the use of an infrared detector and output measuring are generally only suitable for use in association with electric ranges although gas stoves are more common worldwide. Another thing missing from the marketplace is an alarm for the dirtiness of a range hood's grease filter, which would enable well-timed cleaning and thereby a minimization of risks. Nearly all commercially available devices call for a skilled fitter, whereby the purchase price may be even doubled. The price of a monitoring device may become higher than the price of a new kitchen range.

It is an object of the invention to provide an alarm device, whereby the foregoing problems can be avoided and which is substantially less expensive than prior art devices. This object is accomplished by the invention in such a way that the device comprises at least two temperature sensors, which have substantially dissimilar contacts with the radiation heat of a range, and that the identification electronics identifies rates of change in the temperatures of the sensors and/or a temperature difference between the sensors and/or a rate of change in the temperature difference between the sensors and effects the activation of an alarm or a control output as the rates of change in temperatures and/or the temperature difference and/or the rate of change in a temperature difference exceeds or exceed a given value. An alarm device of the invention reminds the user of a left-on gas or electric range plate and an excessively soiled grease filter of the range hood. The solution enables a very rapid identification and alarm in such case that a presently vacant plate of a gas or electric range has been left on, whereby there is not enough time for the user to leave the site, nor is there enough time for the actual overheating to even occur. In the best case, the solution produces an alarm in less than a few minutes, yet allows for a normal operation of the range without restrictions.

The invention can be simply implemented by an alarm capable of being attached to a range hood by means of magnets, thus enabling indication of rapid changes in temperatures conducted to the range hood and exceptional situations. The simplest alarm of the invention measures a rapid change in the temperatures of various sensors at the bottom surface of a range hood, whereby it is capable of signalling a switched-on range plate which has been left at idle. Another solution based on a rapid change of temperature according to the invention measures a difference between the external and internal temperatures of a range hood and/or a rate of change in this temperature difference, thus enabling the identification of not only a left-on range plate but also an excessively soiled grease filter. The change in temperature is rapid whenever a range plate has been left on or switched on at idle. A rapid change results from the fact that the temperature rises quickly when the range plate is vacant or if a heat-absorbing cooking vessel with its contents is removed from the range. A respective rapid change does not take place in the process of preparing food, the food and the vessel heating up slowly. There is a wide temperature difference between the inside and outside of a range hood and the temperature difference experiences rapid changes if the grease filter is excessively dirty, because a soiled grease filter functions as a barrier and impedes the transfer of heat inside the range hood. The interior of a range hood and the cooking area warm up slowly at an almost equal rate when the plate has on top a cooking vessel of food or the grease filter is adequately clean, but the consequence of a vacant switched-on plate or a dirty grease filter is that the vicinity of a range, which is in a direct radiation contact with the range plates, heats up more rapidly than the interior of the range hood. The rather small and rapid change occurring in temperature or in a difference between temperatures is readily and quickly identifiable when a cooking vessel is removed from the range and the plate is inadvertently left on or when cooking is started and the grease filter is sufficiently dirty. The indication of rates of change in temperatures or a difference between temperatures or a rate of change in a temperature difference does not call for the overheating of a range plate, whereby the alerting occurs in less time and at lower temperatures than in prior known solutions which are based merely on overstepping a high maximum temperature. In a solution of the invention, the identification sensitivity is not impaired by ambient temperature and slow changes occurring therein as opposed to traditional solutions, by virtue of which the alerting occurs very quickly as well as reliably. If desired, the alarm control relay can be used for controlling also a range hood and a range. In an alarm situation, it is thus possible to switch off the range hood and the supply of power or gas to the range, and in the best case to prevent overheating of the range and a possible flue fire.

In terms of technical design, the invention is based on a battery-operated or external voltage-feed operated alarm unit, which is mountable on the surface or in the interior of a range hood and which is provided with temperature sensors for measuring the internal and/or external temperature of the range hood. When measuring both external and internal temperature, the unit present inside a range hood is either in wired or wireless communication with a separate unit, which is present outside the range hood on its bottom surface and which is provided with a temperature sensor for measuring temperature external of the range hood. The unit measuring external temperature can be very small and simple, thus being also easy to install and keep clean. By virtue of a simple design and magnet attachment, it can be fitted by anyone and the alarm unit inside the range hood is neither able to become soiled nor to overheat, thus working more reliably and not calling for extra cleaning. At its simplest, the measurement is based on reasonably priced NTC temperature sensors insensitive to dirt and visible flames, yet sensitive to the entire spectrum of thermal radiation. When using NTC sensors, the device lends itself equally well to applications involving gas stoves as well as electric ranges and enables a highly durable battery-operated implementation. The measurement of a rate of change in temperature can also be effected by using a prior known IR measurement. The two-sensor solution, based on a temperature difference or a rate of change in temperature, is also insensitive to ambient temperature and capable of alerting quickly regardless of the thermal output and temperature of a range plate.

The invention will now be described in detail with reference to the accompanying drawing, in which:

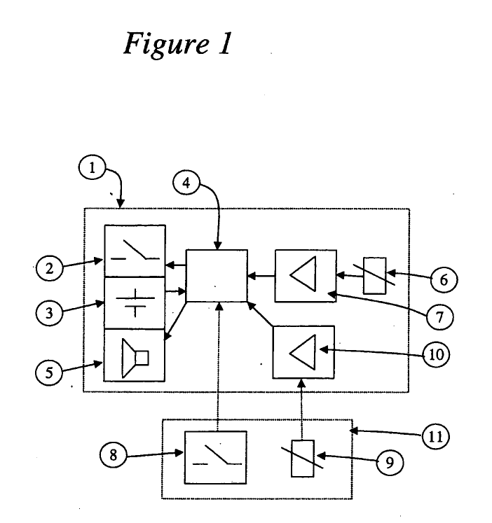

FIG. 1 shows a structural block diagram for an accessory of the invention.

FIG. 1 depicts a block diagram for an alarm, which is used for tracking the internal and external temperatures of a range hood and which is based on per se known technology, comprising a unit 1 to be placed inside the range hood and a unit 11 to be placed outside the range hood, the latter being linked either in a wired or wireless manner to the unit present inside. The unit 1 to be placed inside is provided with a voltage source 3 and identification and control electronics 4 based on a microprocessor or a control logic. The unit 1 measures the internal temperature of a range hood by means of a sensor 6, which has its signal intensified in an amplifier 6 for a mode appropriate for the identification and control electronics 4. The second unit 11, which is mounted on the bottom surface of a range hood, measures temperature external of the range hood by means of a measuring sensor 9 which is linked to an amplifier 10 of the unit 1 and intensified for a mode appropriate for the identification and control electronics 4. The prior art based electronics 4 compares the internal 6 as well as the external 9 temperatures of the range hood and, upon detecting a sufficiently rapid and/or large change, it activates an alarm sound signal 5 and, if necessary, has an external control relay 2 energized. The alarm sound signal 5 can be switched off by a push button 8 included in the unit present outside the range hood. The push button 8 can also be used for programming a desired temperature difference or rate of change in the temperature difference in the memory of the control electronics by simulating an alarm condition, whereby the device can be readily adapted to various operating conditions. Another optional configuration of the alarm can be such that the alarm unit 1 resides outside a range hood and the alarm has its temperature sensors 6, 9 in two separate units 1, 11, one inside its unit and the other outside its unit. What is essential is that the contacts (interactions or relations) thereof with the radiation heat of a range are substantially dissimilar to each other. An alarm fitted with two sensors can be designed as integrated with a range hood.

1. An alarm device, which identifies if the plate of a gas or electric range is on at idle or the grease filter of a range hood is excessively dirty, said device comprising a temperature sensor and identification electronics, which identifies a sensor message and on that basis effects the activation of an alarm or a control output, wherein the device comprises at least two temperature sensors, which have substantially dissimilar contacts with the radiation heat of a range, and that the identification electronics identifies rates of change in the temperatures of the sensors and/or a temperature difference between the sensors and/or a rate of change in the temperature difference between the sensors and effects the activation of an alarm or a control output as the rates of change in temperatures and/or the temperature difference and/or the rate of change in a temperature difference exceeds or exceed a given value.

2. A device as set forth in claim 1, wherein the device comprises two units, which are capable of being disposed in various positions and which are in communication with each other, and each of which is provided with a temperature sensor.

3. A device as set forth in claim 1, wherein the device comprises two temperature sensors, the first of which is disposed or capable of being disposed so as to be shielded from a direct radiation contact with the plates and the second is disposed or capable of being disposed in a direct radiation contact with the plates of a range.

4. A device as set forth in claim 1, wherein the identification electronics identifies the rate of change in a temperature difference between the sensors and effects the activation of an alarm or a control output as the temperature difference has a rate of change which exceeds a given value.

5. A device as set forth in claim 1, wherein the identification electronics identifies the rate of change in the temperature of at least one of the sensors and the temperature difference between the sensors and effects the activation of an alarm or a control output as the temperature rate of change and the temperature difference exceed given values.

6. A device as set forth in claim 1, wherein the alarm is connected or capable of being connected with an external forwarding device or with control electronics for a range or range hood or with an accessory capable of disconnecting power supplies to a range or range hood.

7. A device as set forth in claim 1, wherein the identification electronics comprises a microprocessor, provided with a program which learns normal operating conditions and thereby adapts itself to various makes of equipment and conditions for effecting an alarm in exceptional situations.

8. A device as set forth in claim 1, wherein the device is present as integrated with a range hood or a stove and coupled to control the operation thereof.

9. A device as set forth in claim 1, wherein the device and/or its sensors are/is attachable to the operating positions thereof by means of a magnet.

10. A device as set forth in claim 1, wherein the temperature sensors are NTC sensors.
